(19) United States
(12) Patent Application Publication
(10) Pub. No.: US 2007/0226000 A1
(43) Pub. Date: Sep. 27, 2007

(54) METHOD OF DISTRIBUTING AND MARKETING REPAIR INFORMATION

(76) Inventor: George Lee GARDNER, Boynton Beach, FL (US)

Correspondence Address: GARDNER GROFF GREENWALD & VILLANUEVA, P.C., 2018 POWERS FERRY ROAD, SUITE 800, ATLANTA, GA, 30339, US

(21) Appl. No.: 11/689,045

(22) Filed: Mar. 21, 2007

Related U.S. Application Data
(60) Provisional application No. 60/784,165, filed on Mar. 21, 2006.

(51) Int. Cl. G06Q 10/00; G06Q 30/00

(52) U.S. Cl. 705/1

(57) ABSTRACT

A system and method for delivering targeted, specific repair or task information to allow a consumer to complete a repair or task without having to resort to comprehensive materials. The targeted or specific repair or task information can be delivered to the consumer in a variety of formats, including computer print-outs, CD's, DVD discs, video “clips”, etc. containing instructional “step-by-step” directions of how do to specific repairs and tasks. This allows for a very simple and targeted delivery of information that is specific to the particular problem at hand (instead of trying to sell the customer a comprehensive repair manual). At the time of sale of the item to the consumer, the system retrieves information specific to that item and prompts the seller to offer to sell the specific, targeted information to the consumer for a small fee (or for free).

### CROSS-REFERENCE TO RELATED APPLICATIONS

The benefit of the filing date of U.S. provisional patent application Ser. No. 60/784,165, filed Mar. 21, 2006, is hereby claimed, and the specifications thereof are incorporated herein by this reference.

### BACKGROUND OF THE INVENTION

### Field of the Invention

In recent years, it has become very popular for individuals to engage in “do-it-yourself” repairs for a wide range of activities. For example, many do-it-yourselfers (“DIY'ers”) do home repairs, car repairs, appliance repairs, etc. Oftentimes, the DIY'ers are interested in tackling a project, but lack some basic or technical information needed to handle the project properly. At present, a wide variety of instruction manuals and books are available for this purpose. Such materials are also available in electronic form, such as on CD, DVD, or on-line. However, the instruction manuals cover many topics (are comprehensive) and tend to be expensive. Oftentimes the consumer only wants a little bit of information about a particular job, not a lot of information about a lot of different jobs. In such situations, the relatively high cost or the sheer volume of information to wade through can keep the DIY'er from accessing the information needed for the particular job to be performed.

For example, in the auto salvage business, customers often ask for advice on how to install a part. The auto salvage employees are usually very busy, and often can't give the customer the time to explain how to install the used part. Many times, these customers are even willing to pay money for help and advice. This is true both for walk-in customers and Internet customers.

Accordingly, it can be seen that a need yet remains for distributing and/or marketing repair information in a way to improve access to the information to assist with a particular repair job or other task to be performed. It is to the provision of such a distribution and marketing system and method that the present invention is primarily directed.

### SUMMARY OF THE INVENTION

Briefly described, the present invention comprises a system and method for delivering targeted, specific repair or task information to allow a DIY'er to complete a repair or task without having to resort to comprehensive materials. The targets or specific repair or task information can be delivered to the DIY'er in a variety of formats, including computer print-outs, CD's, DVD discs, video “clips”, etc of instructional “step-by-step” directions of how to do DIY repairs and tasks. These repairs and tasks can be in diverse fields, including automotive repairs and home repairs. For example, if a customer would purchase a taillight from a parts seller and would like to install it himself or herself, he or she often has no idea of how to do it. The parts seller business can print for the customer a step-by-step instructional for that particular part, or sell him a DVD that details how to do it yourself. Alternatively, the seller can sell (or give) the customer a link to a website with the information or can send a targeted email containing just the relevant information. This allows for a very simple and targeted delivery of information that is specific to the particular problem at hand (instead of trying to sell the customer a comprehensive repair manual). This example can be extended to home repairs, small engine repair, bike repair, small appliance repair, etc.

The instructions can be printed or copied to disk (or copied to a website for downloading later) at the time of the purchase of the related part or other item. For example, in the auto industry if a consumer were to buy a set of sparkplugs, the retail check out system (the electronic cash register) could be used to prompt the consumer to purchase a print (or other form of information) of instructions for the sparkplugs he is buying. This has the potential to add a very lucrative sale to the transaction, while at the same time providing targeted information to the consumer at relatively low cost. This targeted information could be priced at a few dollars to even under a dollar (or used as a no-cost promotion to increase sales). Thus, as the customer is checking out, the computer system could use the part number of the item being purchased, retrieve repair or task information related to that part number, prompt the cashier to offer the targeted repair or task information to the customer (at no cost or at a low cost). If offered to the customer for a fee, the system advantageously can create an additional source of revenue for the seller because a good number of customers might be inclined to purchase the information for a nominal fee, fees the seller would not otherwise generate. Importantly, this new source of fees comes without needing to advertise. For the consumer/DIY'er, greater access to the needed information is provided, without requiring the DIY'er to buy more information than he or she needs. This promotes economic efficiency and makes the information more accessible.

As described above, one application for the invention is “do-it-yourself” mechanical or bodywork information for automobiles. However, the invention has good application to many repair subjects, including home repair and renovation, boats, small engines, motorcycles, bicycles, and other sport craft. Also, in addition to repair items, the invention has application to a great many crafts or other tasks. For example, when floor tile is sold, the purchaser might well be interested in obtaining information about how to set the tile.

Many people use repair manuals and instructional books one time, and never again. Many people never even find the section in these books for the job they're attempting. With the present invention, the consumer/customer can get up to the minute information about the particular item being purchased, ensuring the best possible experience in using the item.

### BRIEF DESCRIPTION OF THE DRAWINGS

FIG. 1 is a flow chart depicting operation of the method and system according to a first preferred embodiment of the present invention.

### DETAILED DESCRIPTION

The present invention may be understood more readily by reference to the following detailed description of the invention taken in connection with the accompanying drawing figures, in which like reference numerals represent like parts. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

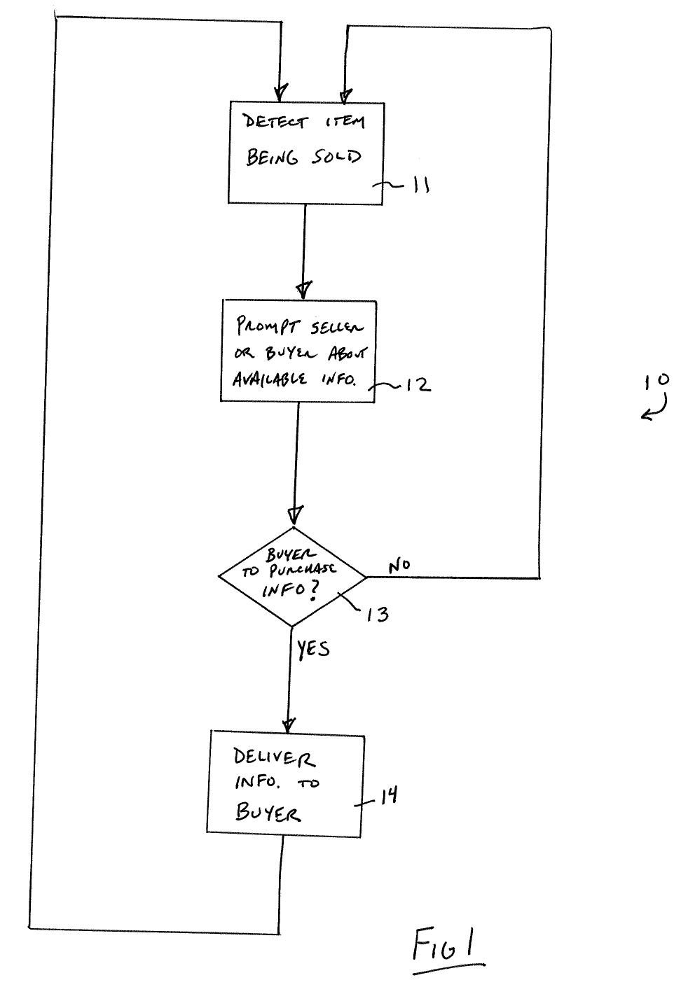

Referring now to FIG. 1, a method and system 10 according to a preferred form of the present invention is depicted therein. In the method and system according to the present invention, the first Step 11 comprises detecting that an item is being sold. This Detecting Step can be in the form of detecting the item as it is rung up at a cash register in a store or can comprise detecting a purchase or an impending purchase in an online transaction. Once the item is detected in Step 11, thereafter a Prompt Step 12 is carried out.

In the Prompt Step 12, the seller is prompted to query the buyer about whether the buyer wants to obtain item-specific or item-targeted information. Alternatively, in some situations it will be desirable to have the system prompt the buyer directly, instead of having the system remind the seller to prompt the buyer. In the context of a retail store, this Prompt Step 12 typically would be carried out by the cashier. Typically, the retail system that manages the cash register and inventory would be provided with a module that, upon detecting that the item is being sold, prompts the cashier to ask if the buyer is interested in obtaining targeted or specific information about the item being purchased. In such an environment, the prompt could be as simple as a pop-up menu or a message reminding the cash register operator to ask the customer if the customer wants item-targeted or item-specific information. Alternatively, the store personnel simply can be trained to do so each time a customer checks out and buys an item. Of course, in some contexts the buyer is effecting the checkout himself or herself. In such an environment, the system can provide a prompt directly to the buyer to inquire whether the buyer would like to obtain the item-targeted or item-specific information. Again, this prompt can take the form of a message or pop-up window that appears on the self checkout cash register or on the computer screen if the transaction is being completed online.

In this Prompt Step 12, the customer or consumer can be queried to find out if the consumer would like to obtain the targeted or specific information for small fee. It is contemplated that the small fee is a few dollars or less, preferably a dollar or two. Alternatively, in some circumstances it may be desirable for the item seller to provide the targeted or specific information at no additional charge. Thus, the Prompt Step 12 can be carried out by asking the consumer or customer if he or she would like to buy or purchase the information. Alternatively, the customer can simply be given the opportunity to be given the information without any additional expense.

As shown in Decision Step 13, if the buyer or customer declines the offer to be provided with the targeted or specific information, the system 10 loops back to Step 11 to continue to monitor for any additional items which might trigger an opportunity to provide the customer with targeted or specific information about the item. Alternatively, instead of constantly polling in this way (checking after every item), the system and method can be configured to only check at the end of the purchasing transaction, perhaps just prior to payment. In this way, the customer can be queried one time about possibly obtaining targeted or specific information about one or more of the items, among the many various items, being purchased by the customer. This promotes efficiency and avoids asking the customer for the same information more than once.

As shown in Decision Step 13, if the buyer or customer decides that yes, he or she does want to obtain or purchase the targeted or specific information relating to the item being purchased, then the system and method can deliverer the targeted or specific information to the customer according to Delivery Step 14. As described earlier, the delivery Step can take a myriad of forms. In some environments, it will be advantageous to simply print out printed instructions, perhaps with illustrations embedded therein, and to hand them to the customer as the customer exits the store. In some situations, the customer can be provided with a digital file stored on a memory disk, memory stick, at a web site, embedded within an e-mail to be delivered to the customer, etc.. If the targeted information is delivered to the customer via disk or memory stick, such typically would be physically handed to the customer at a time of the purchase. Alternatively, if the information is to be delivered to the customer via the Internet or by e-mail, such can be forwarded to the customer at a later time or the customer can access the information at a later time. In these situations, the customer can be provided with a link to a web site and given a unique key code. The customer can then visit the web site and enter the key code, which then causes the delivery of information to the customer either through the web site directly or through an e-mail directed to the customer's e-mail address.

While the invention has been described with reference to preferred and example embodiments, it will be understood by those skilled in the art that a variety of modifications, additions and deletions are within the scope of the invention, as defined by the following claims.

What is claimed is:

1. A method of distributing and marketing repair or task information, the method comprising the steps of:
detecting the sale of an item to a customer;
selecting a repair or task associated with that item;
offering to the customer, at the time of sale or shortly thereafter, repair or task information associated with that item.

2. The method as claimed in claim 1 wherein the step of offering repair or task information to the customer comprises delivering the repair or task information to the customer.

3. The method as claimed in claim 2 wherein the step of delivering repair or task information is carried out in response to a positive response from the customer acceding to the delivery of the information.

4. The method as claimed in claim 2 wherein the step of delivering repair or task information is carried out automatically without requiring a positive response from the customer acceding to the delivery of the information.

5. The method as claimed in claim 1 wherein the repair or task information is presented via printed text.

6. The method as claimed in claim 1 wherein the repair or task information is presented via email.

7. The method as claimed in claim 1 wherein the repair or task information is presented via video images stored on a medium for playback on a television.

8. The method as claimed in claim 1 wherein the repair or task information is presented via delivery to a website for subsequent downloading by the customer.

9. The method as claimed in claim 1 wherein the repair or task information is presented as step-by-step instructions.

10. The method as claimed in claim 1 wherein the repair or task information is presented as a video visually showing how the repair should be done.

11. The method as claimed in claim 1 wherein the item is a vehicle part and the repair or task information relates to how to install or replace the vehicle part.

12. The method as claimed in claim 11 wherein the repair or task information includes technical specifications.

13. The method as claimed in claim 1 wherein item is a home repair item.
